(19) United States
(12) Patent Application Publication
(10) Pub. No.: US 2014/0126995 A1
(43) Pub. Date: May 8, 2014

(54) MICROCHANNEL COOLED TURBINE COMPONENT AND METHOD OF FORMING A MICROCHANNEL COOLED TURBINE COMPONENT

(71) Applicant: GENERAL ELECTRIC COMPANY, Schenectady, NY (US)

(72) Inventors: David Edward Schick, Greenville, SC (US); Srikanth Chandrudu Kottilingam, Simpsonville, SC (US); Benjamin Paul Lacy, Greer, SC (US)

(73) Assignee: General Electric Company, Schenectady, NY (US)

(21) Appl. No.: 13/669,731

(22) Filed: Nov. 6, 2012

(51) Int. Cl. F04D 31/00; B23K 9/04

(52) U.S. Cl. 415/116; 219/76.14

(57) ABSTRACT

A microchannel cooled turbine component includes a first portion of the microchannel cooled turbine component having a substrate surface. Also included is a second portion of the microchannel cooled turbine component comprising a substance that is laser fused on the substrate surface. Further included is at least one microchannel extending along at least one of the first portion and the second portion, the at least one microchannel formed and enclosed upon formation of the second portion.

### BACKGROUND OF THE INVENTION

The subject matter disclosed herein relates to turbine components, and more particularly to a microchannel cooled turbine component, as well as a method of forming a microchannel cooled turbine component.

In gas turbine systems, a combustor converts the chemical energy of a fuel or an air-fuel mixture into thermal energy. The thermal energy is conveyed by a fluid, often compressed air from a compressor, to a turbine where the thermal energy is converted to mechanical energy. As part of the conversion process, hot gas is flowed over and through portions of the turbine as a hot gas path. High temperatures along the hot gas path can heat turbine components, causing degradation of components.

Efforts to cool or maintain suitable temperatures for turbine components have included providing channels of various sizes to distribute a cooling flow within the turbine components. Difficulties exist when forming turbine components having such channels, particularly small channels. Prior methods have included cast in channels and filling channels, then coating channeled components with a thermal barrier coating (TBC), then leeching the fill material out, for example. Each of the aforementioned processes includes unique drawbacks, such as high cost, manufacturing variation, time-intensive labor and durability issues, to name a few.

### BRIEF DESCRIPTION OF THE INVENTION

According to one aspect of the invention, a microchannel cooled turbine component includes a first portion of the microchannel cooled turbine component having a substrate surface. Also included is a second portion of the microchannel cooled turbine component comprising a substance that is laser fused on the substrate surface. Further included is at least one microchannel extending along at least one of the first portion and the second portion, the at least one microchannel formed and enclosed upon formation of the second portion.

According to another aspect of the invention, a method of forming a microchannel cooled turbine component is provided. The method includes forming a first portion having a substrate surface. Also included is depositing a plurality of layers onto the first portion by melting a substance with a laser, the plurality of layers forming a second portion of the microchannel cooled turbine component. Further included is forming and enclosing at least one microchannel extending along at least one of the first portion and the second portion during the depositing of the plurality of layers onto the first portion.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a turbine system;

FIG. 2 is a perspective view of a first portion of a microchannel cooled turbine component;

FIG. 3 is an elevational side view of the first portion;

FIG. 4 is a perspective view of the microchannel cooled turbine component having the first portion and a second portion;

FIG. 5 is an elevational side view of the microchannel cooled turbine component; and

FIG. 6 is a flow diagram illustrating a method of forming the microchannel cooled turbine component.

The detailed description explains embodiments of the invention, together with advantages and features, by way of example with reference to the drawings.

### DETAILED DESCRIPTION OF THE INVENTION

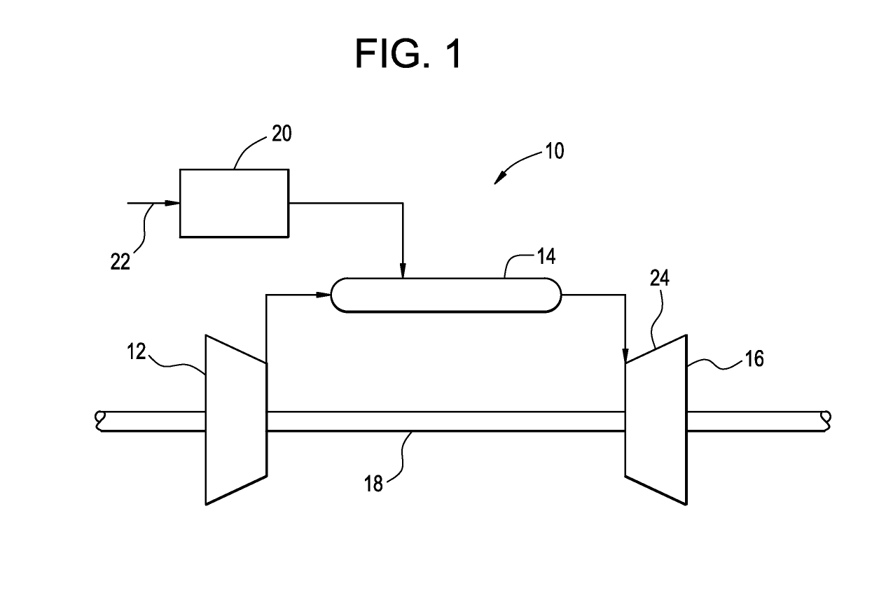

Referring to FIG. 1, a turbine system, such as a gas turbine system is schematically illustrated and generally referred to with numeral 10. The gas turbine system 10 includes a compressor 12, a combustor 14, a turbine 16, a shaft 18 and a fuel nozzle 20. It is to be appreciated that one embodiment of the gas turbine system 10 may include a plurality of compressors 12, combustors 14, turbines 16, shafts 18 and fuel nozzles 20. The compressor 12 and the turbine 16 are coupled by the shaft 18. The shaft 18 may be a single shaft or a plurality of shaft segments coupled together to form the shaft 18.

The combustor 14 uses a combustible liquid and/or gas fuel, such as natural gas or a hydrogen rich synthetic gas, to run the gas turbine system 10. For example, fuel nozzles 20 are in fluid communication with an air supply and a fuel supply 22. The fuel nozzles 20 create an air-fuel mixture, and discharge the air-fuel mixture into the combustor 14, thereby causing a combustion that creates a hot pressurized exhaust gas. The combustor 14 directs the hot pressurized gas through a transition piece into a turbine nozzle (or “stage one nozzle”), and other stages of buckets and nozzles causing rotation of the turbine 16 within a turbine casing 24. Rotation of the turbine 16 causes the shaft 18 to rotate, thereby compressing the air as it flows into the compressor 12. In an embodiment, hot gas path components are located in the turbine 16, where hot gas flow across the components causes creep, oxidation, wear and thermal fatigue of turbine components. Controlling the temperature of the hot gas path components can reduce distress modes in the components. The efficiency of the gas turbine system 10 increases with an increase in firing temperature and the hot gas path components may need additional or increased cooling to meet service life and to effectively perform intended functionality.

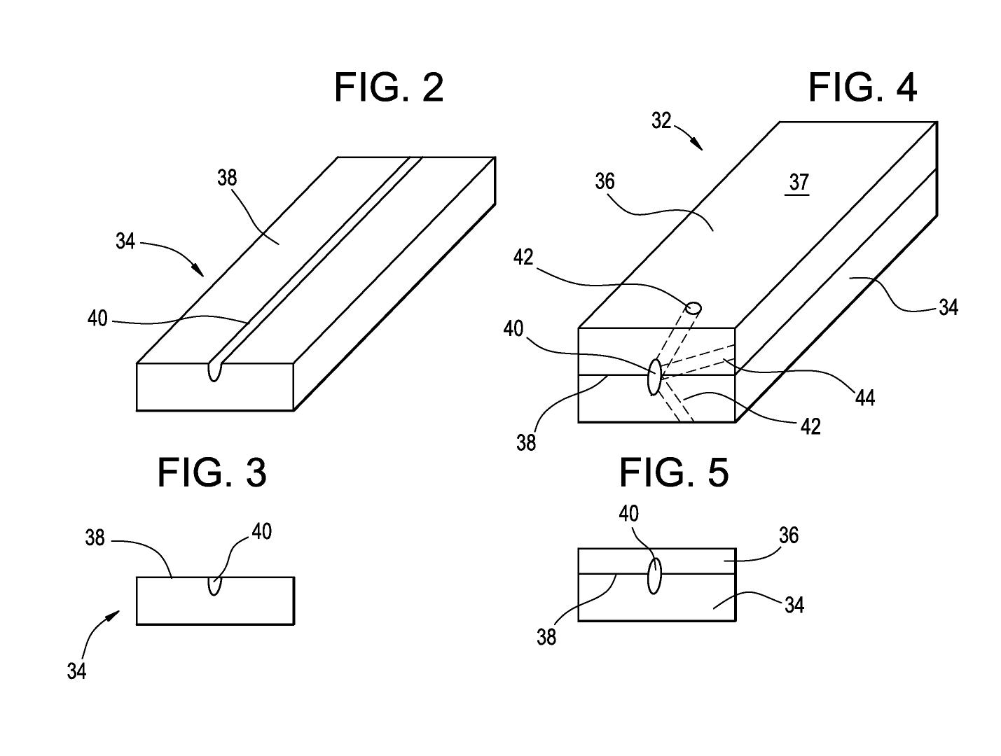

Referring to FIGS. 2-5, as noted above, various hot gas components are located throughout the gas turbine system 10, such as in the turbine 16. Examples of hot gas path components include a turbine shroud, a turbine nozzle and a turbine bucket, however, the preceding examples are merely illustrative and not intended to be limiting. One such component is generally shown as a microchannel cooled turbine component 32, which includes a first portion 34 and a second portion 36. The first portion 34 is a machined component formed of a variety of materials, such as metal, for example. The second portion 36 comprises a plurality of layers of a substance 37 deposited onto the first portion 34 to form the microchannel cooled turbine component 32 as an integral structure. Specifically, the first portion 34 includes a substrate surface 38 which interacts with the first of the plurality of layers deposited onto the first portion 34. Subsequently, numerous additional layers are deposited onto each preceding layer in an additive process that will be described in detail below.

The microchannel cooled turbine component 32 includes at least one microchannel 40 disposed along an interior region of the microchannel cooled turbine component 32. Although illustrated as a single microchannel, it is to be appreciated that a plurality of microchannels may be included. The at least one microchannel 40, in the case of a plurality of microchannels, may be the same or different in size or shape from each other. In accordance with certain embodiments, the at least one microchannel 40 may have a width of between about 100 microns (μm) and about 3 millimeters (mm) and a depth between about 100 μm and about 3 mm, as will be discussed below. For example, the at least one microchannel 40 may have a width and/or depth between about 150 μm and about 1.5 mm, between about 250 μm and about 1.25 mm, or between about 300 μm and about 1 mm. In certain embodiments, the at least one microchannel 40 may have a width and/or depth of less than about 50, 100, 150, 200, 250, 300, 350, 400, 450, 500, 600, 700, or 750 μm. While illustrated as relatively oval in cross-section, the at least one microchannel 40 may be any number of suitable shapes. Indeed, the at least one microchannel 40 may have circular, semi-circular, curved, rectangular, triangular, or rhomboidal cross-sections in addition to or in lieu of the illustrated oval cross-section. The width and depth could vary throughout its length. Additionally, in certain embodiments, the at least one microchannel 40 may have varying cross-sectional areas. Heat transfer enhancements such as turbulators or dimples may be installed in the at least one microchannel 40 as well.

The at least one microchannel 40 is formed during deposition of the substance 37, which forms the second portion 36. The substance 37 is typically a powder that is coated onto the substrate surface 38 and subsequently melted by a laser. The laser power may vary depending on the application and in one embodiment the power ranges from about 100 W to about 10,000 W. Thin wire or thin sheets could be used as an alternative to a powder. The melting of the substance 37 results in a metal that is fusion bonded to the substrate surface 38 in the case of the first layer. Laser powder fusion may be referred to as direct metal laser melting (DMLM). Similar processes that may be used may are referred to as direct metal laser sintering (DMLS), laser powder fusion, or direct metal deposition. These processes may include the use of software that is configured to receive 3-dimensional CAD data to precisely deposit the plurality of layers forming the second portion 36 in a relatively efficient and timely manner. Each of the plurality of layers may vary in thickness, however, in one embodiment the thickness of each layer ranges from about 0.005 mm to about 0.100 mm. In one embodiment, the thickness is about 0.020 mm.

It is to be appreciated that the second portion 36 of the microchannel cooled turbine component 32 comprises a plurality of distinct materials, rather than a single material formed during distribution of the substance 37. A multi-material second portion may be formed by melting the substance 37 to form a first material, then subsequently heat treating, machining, and inspecting the second portion 36, and therefore the microchannel cooled turbine component 32. A distinct material then may be formed and added to the first material to build over the existing second portion with the distinct, second material, thereby forming a multi-material second portion.

The laser powder fusion process described above provides manufacturing capability for any number of geometries, sizes and locations of the at least one microchannel 40. As such, the software noted above may receive data relating to formation of the second portion 36 that corresponds with formation of the at least one microchannel 40. In one embodiment, the at least one microchannel 40 is fully disposed (i.e., 100%) within the first portion 34 proximate the substrate surface 38 and formation of the second portion 36 encloses the at least one microchannel 40. In another embodiment, the at least one microchannel 40 is fully disposed within the second portion 36, such that the substrate surface 38 of the first portion 34 is a relatively flat, flush surface. In yet another embodiment, the at least one microchannel 40 is partially disposed within the first portion 34 and partially disposed within the second portion 36, such that less than 100% of the at least one microchannel 40 is defined by either the first portion 34 or the second portion 36. The previously described embodiments may be achieved by desired mapping of where the substance 37 is to be deposited and melted.

In addition to formation of the at least one microchannel 40, it is contemplated that one or more microchannel feed holes 42 may be formed during deposition of the second portion 36 or alternatively may be formed by a laser removal process of a portion of the second portion 36. Alternatively, the microchannel feed holes 42 may also be pre-drilled or machined into the first portion 34. The microchannel feed holes 42 route a cooling flow or airstream from a source to the at least one microchannel 40 for cooling therein. Additionally, at least one exit air hole 44 could be formed on or within the second portion 36 as part of this forming process. Alternatively, the at least one exit air hole 44 could be formed by a laser removal process of a portion of the second portion 36.

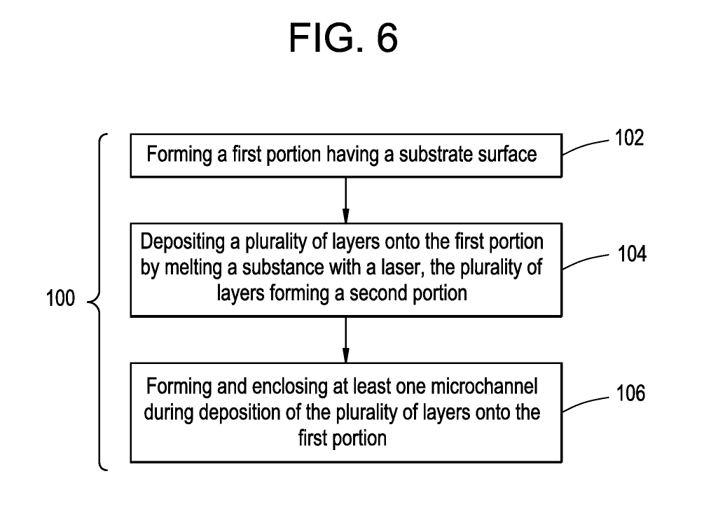

As illustrated in the flow diagram of FIG. 6, and with reference to FIGS. 1-5, a method of forming a microchannel cooled turbine component 100 is also provided. The gas turbine system 10, and more specifically the microchannel cooled turbine component 32 have been previously described and specific structural components need not be described in further detail. The method of forming a microchannel cooled turbine component 100 includes forming a first portion having a substrate surface 102. A plurality of layers is deposited onto the first portion by melting a substance with a laser 104. The plurality of layers, in combination, form the second portion 36 described above. At least one microchannel is formed and enclosed during deposition of the plurality of layers onto the first portion 106.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A microchannel cooled turbine component comprising:
a first portion of the microchannel cooled turbine component having a substrate surface;
a second portion of the microchannel cooled turbine component comprising a substance that is laser fused on the substrate surface; and
at least one microchannel extending along at least one of the first portion and the second portion, the at least one microchannel formed and enclosed upon formation of the second portion.

2. The microchannel cooled turbine component of claim 1, wherein the substance comprises a powder.

3. The microchannel cooled turbine component of claim 2, wherein the powder is configured to form a metal upon melting with a laser.

4. The microchannel cooled turbine component of claim 1, wherein the second portion comprises a plurality of layers.

5. The microchannel cooled turbine component of claim 4, wherein each of the plurality of layers includes a thickness of about 0.005 mm to about 0.100 mm.

6. The microchannel cooled turbine component of claim 1, wherein the at least one microchannel is formed partially in the first portion and partially in the second portion.

7. The microchannel cooled turbine component of claim 1, wherein the at least one microchannel is fully formed in the first portion.

8. The microchannel cooled turbine component of claim 1, wherein the at least one microchannel is fully formed in the second portion.

9. The microchannel cooled turbine component of claim 1, further comprising at least one of a microchannel feed hole and an exit hole is formed during formation of the second portion.

10. The microchannel cooled turbine component of claim 1, wherein the first portion and the second portion form at least a portion of a turbine shroud.

11. The microchannel cooled turbine component of claim 1, wherein the first portion and the second portion form at least a portion of at least one of a turbine nozzle and a turbine bucket.

12. The microchannel cooled turbine component of claim 1, wherein the second portion comprises a plurality of distinct materials.

13. A method of forming a microchannel cooled turbine component comprising:
forming a first portion having a substrate surface;
depositing a plurality of layers onto the first portion by melting a substance with a laser, the plurality of layers forming a second portion of the microchannel cooled turbine component; and
forming and enclosing at least one microchannel extending along at least one of the first portion and the second portion during the depositing of the plurality of layers onto the first portion.

14. The method of claim 13, wherein the second portion comprises a first material, the method further comprising depositing a plurality of layers of a second material distinct from the first material onto the second portion, thereby forming the second portion with a plurality of distinct materials.

15. The method of claim 13, wherein depositing each of the plurality of layers includes depositing a layer having a thickness of about 0.005 mm to about 0.100 mm.

16. The method of claim 13, further comprising forming at least one of a microchannel feed hole and an exit hole during the depositing of the plurality of layers onto the first portion.

17. The method of claim 13, wherein the at least one microchannel is fully formed in the first portion and enclosed with the second portion.

18. The method of claim 13, wherein the at least one microchannel is fully formed in the second portion during depositing of the plurality of layers onto the first portion.

19. The method of claim 13, wherein the at least one microchannel is partially formed in the first portion and partially formed in the second portion.

20. The method of claim 13, wherein the forming of the first portion and the second portion comprises forming at least a portion of at least one of a turbine shroud, a turbine nozzle and a turbine bucket.
